(19) United States
(12) Patent Application Publication
(10) Pub. No.: US 2016/0127832 A1
(43) Pub. Date: May 5, 2016

(54) SPEAKER DIAPHRAGM SUPPORTING STRUCTURE

(71) Applicant: MEILOON INDUSTRIAL CO., LTD., Taoyuan County (TW)

(72) Inventor: Yeh-Feng Chou, Taoyuan City (TW)

(21) Appl. No.: 14/527,855

(22) Filed: Oct. 30, 2014

(51) Int. Cl. H04R 7/16

(52) U.S. Cl. CPC H04R 7/16

(57) ABSTRACT

A speaker diaphragm supporting structure includes a basket defining a flared front opening and an internal shoulder portion, and having annular magnet mounted to a rear side thereof; a voice coil located in the annular magnet; a diaphragm including a soft suspended flange for fixing to the flared front opening of the basket, a rigid vibrating membrane having a centered voice coil fixing hole for gluing to around the voice coil, a plurality of supporting legs integrally formed on a rear side thereof and a fixing ring portion glued to rear ends of the supporting legs; and a flexible suspension member having an outer circumferential edge set on the internal shoulder portion of the basket and an inner circumferential edge glued to the fixing ring portion, so that the suspension member is held to around an outer side of the annular magnet.

### FIELD OF THE INVENTION

The present invention relates to a speaker diaphragm supporting structure, and more particularly to a speaker diaphragm that includes a plurality of supporting legs integrally formed on a rear side thereof, so that the diaphragm has increased structural strength with reduced gluing positions, which enables accurate alignment of speaker components with one another, simplified assembling procedures and accordingly convenient assembling of the speaker to largely increase the rate of yield of the speaker, and the produced speaker can work normally to output good sound quality without becoming failed easily.

### BACKGROUND OF THE INVENTION

With the quick development in the technological fields, novel and improved audio and visual (A/V) apparatus are constantly introduced into the market, and consumers also have constantly increased demand on the sound quality of the market available A/V apparatus. While the A/V apparatus must be of high quality, the speakers serving as the output devices of the A/V apparatus are also an important factor that has decisive influence on the sound quality.

FIG. 1 is an assembled sectional view showing the structure of a conventional speaker. As shown, the speaker includes a basket defining a flared front opening and has an annular magnet mounted to a bottom thereof, a voice coil located inside the annular magnet, a diaphragm glued to between the flared front opening of the basket and the voice coil, and a flexible suspension member located behind and spaced from the diaphragm. While the conventional speaker with the above structure provides good sound quality, it has a relatively big volume in a fully assembled state and is therefore not suitable for mounting in the new-generation A/V products that have small volume and very limited internal space. In the event the conventional speaker is correspondingly reduced in size to match the small internal space of the new-generation A/V products, the sound wave output by the size-reduced speaker would not be able to effectively lower its lowest resonant frequency, which disadvantageously results in inferior sound effect.

Since the conventional diaphragm is generally designed to be a cone in shape, the suspension member must be glued to around the voice coil after the diaphragm and the voice coil are assembled to each other. This is the main cause that prevents the conventional speaker from having an effectively reduced volume.

To break through the limitation in the structure of the conventional speaker diaphragm, some improved speaker structures have been developed. For example, U.S. Pat. No. 5,734,132 discloses a concentric tube suspension system for speakers, which includes a tubular stabilizer concentrically provided around and spaced from an outer side of the voice coil below the diaphragm, and the tubular stabilizer has a lower portion fitted around to cover a part of the magnet and allowing a lower suspension member to glue thereto. With these arrangements, the speaker in a fully assembled state can have an effectively reduced volume.

However, the speaker disclosed in U.S. Pat. No. 5,734,132 still has a conventional cone-shaped diaphragm. Therefore, in assembling the speaker, two gluing steps are needed to glue the diaphragm and the lower suspension member to the upper and the lower end of the tubular stabilizer, respectively. It is relatively difficult to accurately align the diaphragm and the lower suspension member with the upper and the lower end of the tubular stabilizer, respectively, and complicated procedures are involved in assembling the speaker. Further, the speaker components must be very firmly glued to one another to avoid defective products. Since the tubular stabilizer is an additionally provided component with upper and lower ends glued to the diaphragm and the lower suspension member, the diaphragm and the lower suspension member are possibly separated from the tubular stabilizer when the speaker with the above structure has been used over a long period of time. As a result, the speaker would not be able to work normally and would output sound with noise.

### SUMMARY OF THE INVENTION

A primary object of the present invention is to provide a speaker diaphragm supporting structure, which includes a basket defining a flared front opening and an internal shoulder portion, and having annular magnet mounted to a rear side thereof; a voice coil located in the annular magnet; a diaphragm located at the flared front opening of the basket with a centered voice fixing hole glued to around the voice coil, the diaphragm including a soft suspended flange for fixing to the flared front opening of the basket, a rigid vibrating membrane having the centered voice coil fixing hole for gluing to around the voice coil, a plurality of supporting legs integrally formed on a rear side of the diaphragm, and a fixing ring portion glued to rear ends of the supporting legs; and a flexible suspension member having an outer circumferential edge set on the internal shoulder portion of the basket and an inner circumferential edge glued to the fixing ring portion, so that the suspension member is held to around an outer side of the annular magnet.

A speaker using the diaphragm supporting structure of the present invention can have effectively reduced overall height and volume, and the diaphragm with the supporting legs integrally formed thereon has increased structural strength with reduced gluing positions, which enables accurate alignment of speaker components with one another, simplified assembling procedures and accordingly convenient assembling of the speaker to largely increase the rate of yield of the speaker, and the produced speaker can work normally to output good sound quality without becoming failed easily.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled sectional side view showing the structure of a conventional speaker;

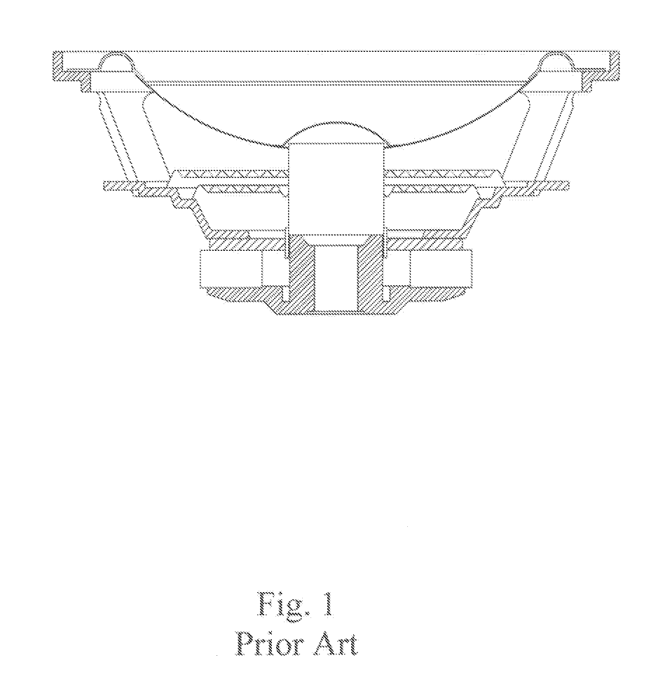

FIG. 2 is an assembled sectional side view of the present invention;

FIG. 3 is an exploded perspective view of the present invention;

FIG. 4 is a fragmentary sectional side view showing the present invention in use; and

FIG. 5 is a top view of the present invention, showing a diaphragm thereof can have differently shaped top covers connected thereto for decoration.

### DETAILED DESCRIPTION OF THE PREFERRED EMBODIMENTS

The present invention will now be described with a preferred embodiment thereof and by referring to the accompanying drawings.

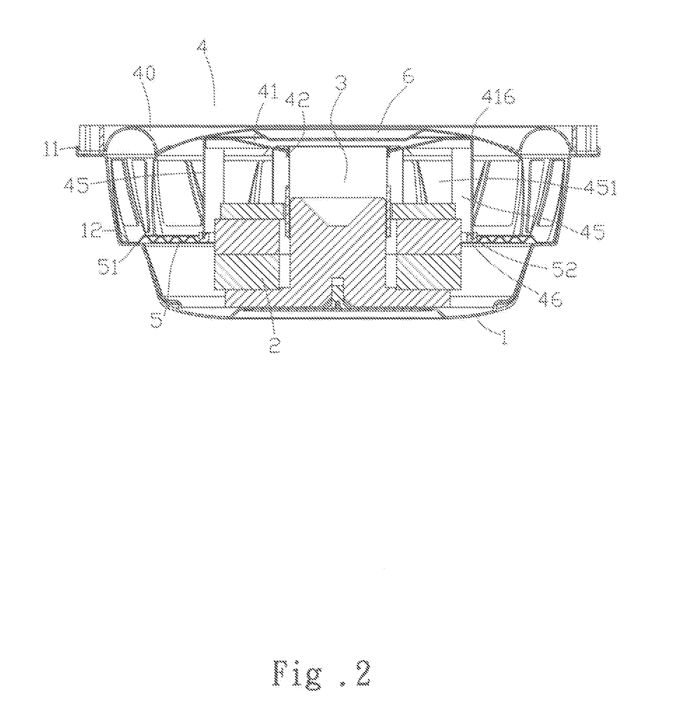

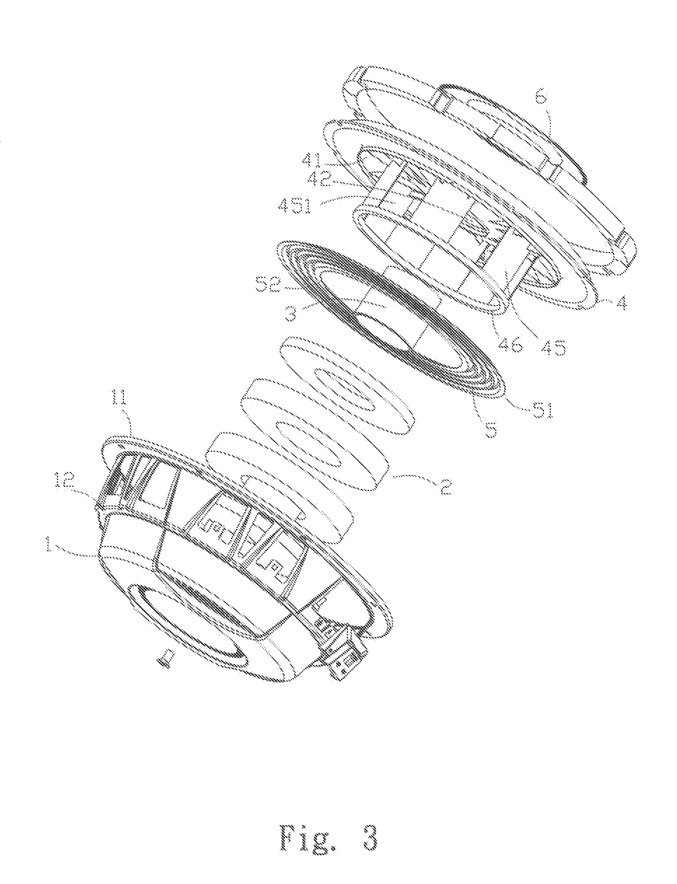

Please refer to FIGS. 2 to 4. The speaker diaphragm supporting structure according to a preferred embodiment of the present invention includes a basket 1 defining a flared front opening 11 and an internal shoulder portion 12, and having annular magnet 2 mounted to a bottom thereof; a voice coil 3 located in the annular magnet 2; a diaphragm 4 located at the flared front opening 11 with a centered voice coil fixing hole 42 glued to around the voice coil 3; and a flexible suspension member 5 having an outer circumferential edge 51 and an inner circumferential edge 52.

The speaker diaphragm supporting structure according to the present invention is characterized by the diaphragm 4, which includes a soft suspended flange 40 fixed to the flared front opening 11 of the basket 1, a rigid vibrating membrane 41 having the centered voice coil fixing hole 42 formed thereon for gluing to around the voice coil 3, a plurality of supporting legs 45 integrally formed on a rear side of the diaphragm 4, and a fixing ring portion 46 glued to rear ends of the supporting legs 45 and to the inner circumferential edge 52 of the suspension member 5. The speaker diaphragm supporting structure also functions to hold the suspension member 5 to around an outer side of the annular magnet 2. In practical implementing of the present invention, the diaphragm 4 can be made of a metal material, a plastic material or a paper material. The supporting legs 45 are circumferentially spaced from one another by a predetermined ventilation spacing 451. The fixing ring portion 46 has a U-sectioned front side for gluing to the supporting legs 45, and a flat rear side for gluing to the inner circumferential edge 52 of the suspension member 5.

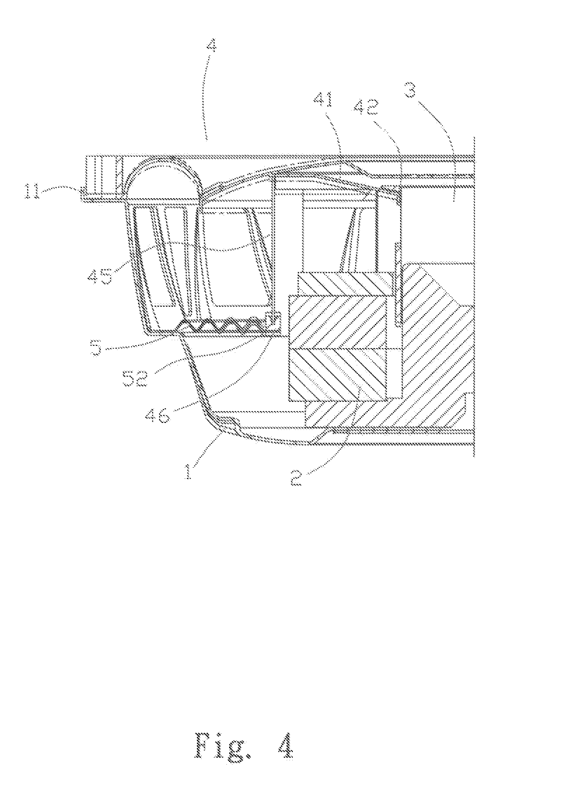

Please refer to FIGS. 2 and 4. When a speaker using the present invention is fully assembled, it has effectively reduced overall height and volume and can therefore be mounted in an LCD television set or other electric products that have decreased dimensions and limited internal space. The supporting legs 45 are helpful in stabilizing the vibration of the voice coil 3, so that the voice coil 3 moving forward and backward in a piston motion can have good conforming flexibility to vibrate stably, which properly increases the vibration amplitude and the vibration stability of the speaker, allowing the speaker to have properly enhanced bass response to produce good acoustic resonance and to well coordinate power and sound wave to ensure upgraded sound quality.

With the supporting legs 45 integrally formed on the rear side of the diaphragm 4, the diaphragm 4 can have increased structural strength, and positions on the diaphragm 4 that require gluing are reduced to enable accurate alignment of the diaphragm 4 with the flared front opening 11, the voice coil 3 and the suspension member 5, making the assembling of the speaker more easily. These advantages in turn effectively simplify the assembling procedures of the speaker and largely increase the rate of yield thereof. Further, the reduced number of glued positions also reduces the risk of having separated components after the speaker has been used over a long period of time. Accordingly, the present invention effectively reduces the chances of failure of the speaker and advantageously ensures normal working of the speaker to output good sound quality.

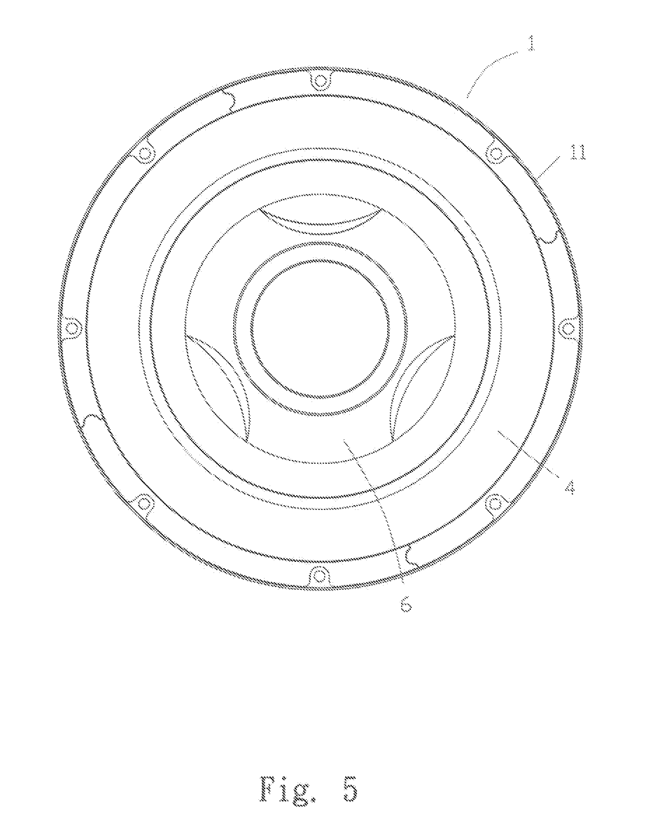

Please refer to FIG. 5 along with FIG. 2. The diaphragm 4 can be integrally formed of a metal material, a plastic material or a paper material with a connection section 416 conveniently provided on a top thereof. Differently designed top covers 6 may be selectively assembled to the diaphragm 4 at the connection section 416, so that the produced speakers can have changeful looks to meet market demands.

In summary, a speaker using the novel speaker diaphragm supporting structure of the present invention can have effectively reduced overall height and volume, and the diaphragm with the supporting legs integrally formed thereon has increased structural strength with reduced gluing positions, which enables accurate alignment of speaker components with one another, simplified assembling procedures and accordingly convenient assembling of the speaker to largely increase the rate of yield thereof, and the produced speaker can work normally to output good sound quality without becoming failed easily.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A speaker diaphragm supporting structure, comprising:
a basket defining a flared front opening and an internal shoulder portion, and having annular magnet mounted to a rear side thereof;
a voice coil being located in the annular magnet;
a diaphragm being located at the flared front opening of the basket with a centered voice coil fixing hole glued to around the voice coil; the diaphragm being characterized by including a soft suspended flange for fixing to the flared front opening of the basket, a rigid vibrating membrane having the centered voice coil fixing hole for gluing to around the voice coil, a plurality of supporting legs integrally formed on a rear side of the diaphragm, and a fixing ring portion glued to rear ends of the supporting legs; and
a flexible suspension member having an outer circumferential edge set on the internal shoulder portion of the basket and an inner circumferential edge glued to the fixing ring portion, so that the suspension member is held to around an outer side of the annular magnet;
whereby a speaker using the diaphragm supporting structure can have effectively reduced overall height and volume, and the diaphragm with the supporting legs integrally formed thereon has increased structural strength with reduced gluing positions, which enables accurate alignment of speaker components with one another, simplified assembling procedures and accordingly convenient assembling of the speaker to largely increase the rate of yield thereof, and the produced speaker can work normally to output good sound quality without becoming failed easily.

2. The speaker diaphragm supporting structure as claimed in claim 1, wherein the supporting legs are circumferentially spaced from one another by predetermined ventilation spacing.

3. The speaker diaphragm supporting structure as claimed in claim 2, wherein the fixing ring portion has a U-sectioned front side for gluing to the supporting legs, and a flat rear side for gluing to the inner circumferential edge of the suspension member.

4. The speaker diaphragm supporting structure as claimed in claim 3, wherein the diaphragm is made of a material selected from the group consisting of a metal material, a plastic material, and a paper material.

5. The speaker diaphragm supporting structure as claimed in claim 4, wherein the diaphragm is provided on a top with a connection section, to which a top cover is connected.
